(19) United States
(12) Patent Application Publication
(10) Pub. No.: US 2018/0171130 A1
(43) Pub. Date: Jun. 21, 2018

(54) Rubber Composition and Refrigerant-Transporting Hose

(71) Applicant: The Yokohama Rubber Co., LTD., Minato-ku, Tokyo (JP)

(72) Inventor: Aya Sato, Hiratsuka-shi, Kanagawa (JP)

(21) Appl. No.: 15/745,416

(22) PCT Filed: Jul. 4, 2016
(86) PCT No.: PCT/JP2016/069817

§ 371 Date: Jan. 16, 2018

(30) Foreign Application Priority Data
Jul. 16, 2015 (JP) 2015-142308

(51) Int. Cl. C08L 23/22; F16L 11/08

(52) U.S. Cl. CPC C08L 23/22; C08L 2205/03; F16L 11/08

(57) ABSTRACT

Provided are a rubber composition containing: a rubber component including at least one selected from the group consisting of chlorosulfonated polyethylene rubber, butyl rubber, and chlorinated polyethylene rubber; and liquid butyl rubber, and being used to manufacture a refrigerant-transporting hose; and a refrigerant transport hose fabricated using the same.

### TECHNICAL FIELD

The present technology relates to a rubber composition and a refrigerant-transporting hose.

### BACKGROUND ART

Hoses for passing refrigerants such as fluorine-based compounds (i.e., refrigerant-transporting hoses) are conventionally used in automobile engine bays.

Recently, there has been a demand for a refrigerant-transporting hose including tube rubber in an inner tube thereof in order to suppress noise from the engine bay caused by engine vibration.

Rubber layer materials containing, for example, butyl rubber or the like have been proposed as rubber compositions for use in inner tubes (for example, see Japanese Unexamined Patent Application Publication No. 2006-29443).

A preparation and evaluation of rubber compositions containing butyl rubber and liquid polybutene performed by the inventor of the present technology on the basis of Japanese Unexamined Patent Application Publication No. 2006-29443 revealed that such rubber compositions have low refrigerant permeation resistance.

### SUMMARY

The present technology provides a rubber composition with superior refrigerant permeation resistance.

The present technology provides a refrigerant-transporting hose of superior refrigerant permeation resistance.

The present technology provides the following features.

1. A rubber composition containing: a rubber component including at least one selected from the group consisting of chlorosulfonated polyethylene rubber, butyl rubber, and chlorinated polyethylene rubber; and liquid butyl rubber; the composition being used to manufacture a refrigerant-transporting hose.

2. The rubber composition according to 1, wherein the liquid butyl rubber has a weight average molecular weight of 1000 to 50000.

3. The rubber composition according to 1 or 2, wherein the liquid butyl rubber has a viscosity at 90° C. of 10000 to 600000 cP.

4. The rubber composition according to any one of 1 to 3, wherein a liquid butyl rubber content is 1 to 30 parts by mass per 100 parts by mass of the rubber component.

5. The rubber composition according to any of 1 to 4, wherein the refrigerant includes at least a fluorine-based compound.

6. A refrigerant-transporting hose fabricated (manufactured) using the rubber composition according to any one of 1 to 5.

The rubber composition and refrigerant-transporting hose of the present technology have superior refrigerant permeation resistance.

### BRIEF DESCRIPTION OF DRAWINGS

FIG. 1 is a perspective view illustrating a cut-away of the layers of one example of a refrigerant-transporting hose according to the present technology.

FIG. 2 is a cross-sectional view of an evaluation cup used to evaluate the refrigerant permeation resistance of the rubber composition according to the present technology.

### DETAILED DESCRIPTION

Embodiments of the present technology are described in detail below.

In the present description, numerical ranges indicated using “(from) . . . to . . . ” include the former number as the lower limit value and the later number as the upper limit value.

In the present description, when a component contains two or more types of substances, the content of said component is the total content of the two or more types of substances.

### Rubber Composition

The rubber composition according to the present technology is a rubber composition containing: a rubber component including at least one selected from the group consisting of chlorosulfonated polyethylene rubber, butyl rubber, and chlorinated polyethylene rubber; and liquid butyl rubber; the composition being used to manufacture a refrigerant-transporting hose.

The rubber composition according to the present technology is thought to yield the desired effects as a result of having such features. While the reasons for this are unclear, it is presumed that the inclusion of crosslinkable liquid butyl rubber in the rubber composition according to the present technology increases the crosslink density of the obtained rubber, thereby yielding superior refrigerant permeation resistance.

The components contained in the rubber composition of the present technology will be described in detail below.

### Rubber Component

The rubber component contained in the rubber composition according to the present technology includes at least one selected from the group consisting of chlorosulfonated polyethylene rubber, butyl rubber, and chlorinated polyethylene rubber. In the present technology, butyl rubber excludes liquid butyl rubber.

There is no particular limitation on the chlorosulfonated polyethylene rubber (CSM). Examples thereof include conventionally known chlorosulfonated polyethylene rubber.

There is no particular limitation on the chlorinated polyethylene rubber (CM). Examples thereof include conventionally known chlorinated polyethylene rubber.

There is no particular limitation on the butyl rubber (IIR). Examples thereof include conventionally known butyl rubber.

An example of a preferable aspect is one in which the butyl rubber is solid at 23° C.

For the sake of obtaining superior effects of the present technology (refrigerant permeation resistance) and superior workability of the unvulcanized rubber composition, the butyl rubber preferably has a weight average molecular weight of greater than 50000 up to 2500000.

In the present technology, the weight average molecular weight of the butyl rubber is a polystyrene standard value calculated on the basis of a value measured via gel permeation chromatography (GPC) using tetrahydrofuran (THF) as a solvent.

An example of a preferred aspect is one in which the rubber component includes at least butyl rubber. The rubber component may be entirely butyl rubber.

An example of a combination for the rubber component include a combination containing butyl rubber and at least one selected from the group consisting of chlorosulfonated polyethylene rubber and chlorinated polyethylene rubber.

The butyl rubber content is preferably 50 to 100 mass % with respect to the total mass of the rubber component.

### Liquid Butyl Rubber

There is no particular limitation on the liquid butyl rubber contained in the rubber composition according to the present technology as long as it is butyl rubber that is viscous at 23° C.

For the sake of obtaining superior effects of the present technology, the weight average molecular weight of the liquid butyl rubber is preferably 1000 to 50000, more preferably to 10000 to 45000.

In the present technology, the weight average molecular weight of the liquid butyl rubber is a value obtained by gel permeation chromatography (GPC) measured based on calibration with polystyrene standard using tetrahydrofuran as a solvent.

For the sake of obtaining superior effects of the present technology, the viscosity at 90° C. of the liquid butyl rubber is preferably 10000 to 600000 cP, more preferably 10000 to 300000 cP.

In the present technology, the viscosity of the liquid butyl rubber is as measured using a Brookfield viscometer (type-B rotational viscometer at a rotational speed of 2.5 rpm and 90° C.; produced by EKO Instruments; type-C viscometer; No. 3 spindle).

A single type or a combination of two or more types of liquid butyl rubber can be used.

For the sake of obtaining superior effects of the present technology and superior compression set resistance and vulcanization properties (e.g., modulus), the liquid butyl rubber content is preferably 1 to 30 parts by mass, more preferably 5 to 15 parts by mass, per 100 parts by mass of the rubber component.

### Filler

An example of a preferable aspect is one in which the rubber composition according the present technology further contains a filler for the sake of obtaining superior effects of the present technology.

Examples of fillers include carbon black, silica, clay, talc, calcium carbonate, mica and diatomaceous earth.

Talc is especially preferable for the sake of obtaining superior effects of the present technology and superior refrigerant permeation resistance.

A single type or a combination of two or more types of filler can be used.

For the sake of obtaining superior effects of the present technology and superior compression set resistance, refrigerant permeation resistance, and modulus, the filler content is preferably 50 to 180 parts by mass, more preferably 70 to 150 parts by mass, per 100 parts by mass of the rubber component.

An example of a preferable aspect is one in which the rubber composition according to the present technology contains substantially no organic clay.

Organic clay means clay to which organic onium ions have been ionically bonded. There is no particular limitation on the organic onium ions. Examples include cations including at least one selected from the group consisting of nitrogen atoms, phosphorus atoms, sulfur atoms, and carbon atoms. Specific examples include NH⁴⁺, phosphonium ions, sulfonium ions, and ammonium ions including a hydrocarbon group.

Containing substantially no organic clay means that the organic clay content is 0 to 0.1 mass % with respect to the total mass of the rubber composition.

### Additives

The rubber composition of the present technology may further contain an additive, as necessary.

Examples of additives include rubber other than the rubber component, liquid rubber other than liquid butyl rubber, softeners such as paraffin oil, stearic acid, zinc oxide, anti-aging agents, antioxidants, antistatic agents, flame retardants, vulcanizing agents such as sulfur or resin vulcanizing agents, vulcanization accelerators, cross-linking agents such as peroxides, and adhesive aids.

There is no particular limitation on the additives. Examples thereof include conventionally known additives.

The additives can be added in suitable amounts.

In a case that the rubber composition according to the present technology further contains a resin vulcanizing agent, examples of the resin vulcanizing agent include an alkylphenol-formaldehyde resin and a brominated alkylphenol-formaldehyde resin.

The resin vulcanizing agent content is preferably 1 to 8 parts by mass, more preferably 2 to 6 parts by mass, per 100 parts by mass of the rubber component.

### Production Method, Applications, Etc.

There is no particular limitation on the method by which the rubber composition according to the present technology is produced. One example is a method in which the rubber component, liquid butyl rubber, and fillers and additives that can be added as necessary are kneaded at 30 to 150° C. in a closed mixer such as a Banbury mixer or a kneader, or a kneading roll, to produce a rubber composition.

There is no particular limitation on the conditions under which the rubber composition according to the present technology is vulcanized or crosslinked. For example, the rubber composition according to the present technology can be vulcanized or crosslinked under pressure at 140 to 160° C.

The rubber composition according to the present technology can be used to manufacture (fabricate) a refrigerant-transporting hose. There is no particular limitation on the part of the refrigerant-transporting hose for which the rubber composition according to the present technology is used; an example of a preferable aspect is one in which the rubber composition according to the present technology is used to form an inner tube of the refrigerant-transporting hose.

There is no particular limitation on the refrigerant passed through the refrigerant-transporting hose. Examples include fluorine-based compounds. Specific examples include fluorine-based compounds including double bonds, such as 1,2,3,3,3-pentafluoropropene, 1,3,3,3-tetrafluoropropene, 2,3,3,3-tetrafluoropropene (structural formula: CF₃—CF═CH₂, HFO-1234yf), 1,2,3,3-tetrafluoropropene, and 3,3,3-trifluoropropene; and saturated hydroflurocarbons such as HFC-134a (structural formula: CF₃—CFH₂).

A single type or a combination of two or more types of refrigerant can be used.

### Refrigerant-Transporting Hose

The refrigerant-transporting hose according to the present technology (hose according to the present technology) is a refrigerant-transporting hose manufactured using the rubber composition according to the present technology.

There is no particular limitation on the rubber composition used for the hose according to the present technology as long as it is the rubber composition of the present technology.

An example of the hose according to the present technology is a hose including an inner tube, a reinforcing layer, and an outer tube, in that order.

### Inner Tube

The inner tube of the hose according to the present technology is preferably formed using the rubber composition according to the present technology.

The inner tube can have one or multiple layers.

In a case that the inner tube includes multiple layers, it is preferable that at least an innermost layer of the inner tube be formed using the rubber composition according to the present technology. An interlayer rubber layer or the like may be disposed between adjacent inner tubes.

An interlayer rubber layer or the like may be disposed between the inner tube and the reinforcing layer adjacent to the inner tube.

### Reinforcing Layer

There is no particular limitation on the reinforcing layer as long as it can be used in a hose.

Examples of the material used for the reinforcing layer includes fiber materials such as polyester fibers, polyamide fibers, aramid fibers, vinylon fibers, rayon fibers, polyparaphenylene benzobisoxazole fibers, polyketone fibers, and polyarylate fibers; and metal materials such as hard steel wire, such as brass-plated wire, and zinc-plated wire.

There is no particular limitation on the geometry of the reinforcing layer. Examples thereof include a braided shape and spiral shape.

A single type or a combination of two or more types of reinforcing layer material can be used.

The reinforcing layer may have one or multiple layers.

In a case that the reinforcing layer has multiple layers, an interlayer rubber layer or the like may be disposed between adjacent reinforcing layers.

### Outer Tube

There is no particular limitation on the rubber material constituting the outer tube. For example, a conventionally known rubber composition can be used. Specific examples include a styrene-butadiene rubber composition, a chloroprene rubber composition, and an ethylene-propylene diene rubber composition.

The outer tube may have one or multiple layers.

In a case that the outer tube has multiple layers, an interlayer rubber layer or the like may be disposed between adjacent outer tube layers.

An interlayer rubber layer or the like may be disposed between the outer tube and the reinforcing layer adjacent to the outer tube.

The hose according to the present technology will now be described on the basis of the preferred embodiment illustrated in the attached drawing. The hose according to the present technology is not limited to the preferred embodiment illustrated in the drawing.

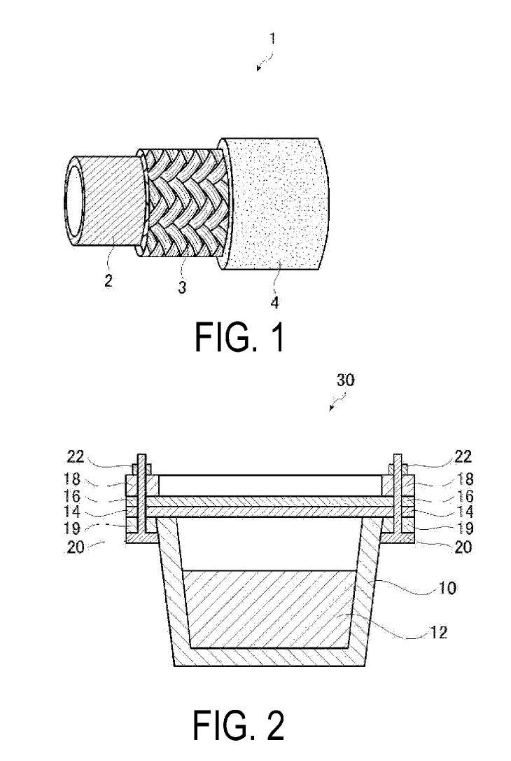

FIG. 1 is a perspective view illustrating a cut-away of the layers of one example of a refrigerant-transporting hose according to the present technology.

In FIG. 1, a refrigerant-transporting hose 1 includes an inner tube 2, a reinforcing layer 3 disposed adjacent to the outer circumferential side of the inner tube 2, and an outer tube 4 disposed adjacent to the outer circumferential side of the reinforcing layer 3.

An example of a preferable aspect is one in which the inner tube 2 of the refrigerant-transporting hose 1 is formed using the rubber composition according to the present technology.

There is no particular limitation on the method used to manufacture the refrigerant-transporting hose according to the present technology. An example is the following method.

First, the inner tube is formed by extruding inner tube material from an inner tube rubber material rubber extruder onto a mandrel to which a release agent has been applied in advance. The inner tube material is preferably the rubber composition according to the present technology.

Next, the reinforcing layer is formed on the inner tube (or adhesive layer if one is present). There is no particular limitation on the method by which the reinforcing layer is formed.

Next, the outer tube is formed by extruding outer tube material onto the reinforcing layer (or adhesive layer in a case that one is present).

The layers can then be bonded via vulcanization at 130 to 190° C. for 30 to 180 minutes to manufacture the hose according to the present technology. Examples of vulcanization methods include steam vulcanization, oven vulcanization (dry heat vulcanization), and hot water vulcanization.

The hose according to the present technology is a refrigerant-transporting hose. The hose according to the present technology can be used, for example, as a fluid-transporting hose such as a hose for use in air conditioning systems (for example, car air conditioning systems).

### EXAMPLES

The present technology will now be described in detail by way of examples; however, the present technology is not limited to these examples.

### Production of Rubber Compositions

The components listed in the following Table 1 were kneaded according to the compositions (part by mass) listed therein at 30 to 150° C. using a closed mixer to produce rubber compositions.

### Preparation of Sheets

The rubber compositions produced as described above were vulcanized at 160° C. for 30 minutes using a press vulcanizing machine to prepare 0.5 mm-thick sheets.

### Evaluation

The following evaluations were performed using the rubber compositions and sheets produced as described above. The results are shown in Table 1.

### Refrigerant Permeation Resistance

The refrigerant permeation resistance evaluation method will now be described using the attached drawings.

FIG. 2 is a cross-sectional view of an evaluation cup used to evaluate the refrigerant permeation resistance of the rubber composition according to the present technology.

In FIG. 2, an evaluation cup 30 includes a stainless steel cup 10 (hereafter referred to as “cup 10”), a sheet 14 prepared as described above, a sintered metal plate 16, fixing members 18, 19, a bolt 20, and a nut 22. The interior of the cup 10 contains refrigerant 12.

First, the cup 10 was filled with refrigerant 12 to half the capacity of the cup 10, the opening of the cup 10 was covered by the sheet 14, and the sintered metal plate 16 was laid over the sheet 14. Next, the end of the cup 10, the sheet 14, and the sintered metal plate 16 were secured with the bolt 20 and the nut 22 via the fixing members 18, 19, and the end of the cup 10, the sheet 14, and the sintered metal plate 16 were brought into tight contact to prepare an evaluation cup 30.

HFO-134a (produced by Daikin Industries) was used as the refrigerant in the examples and comparative examples.

A test was performed in which the evaluation cup prepared as described above was left standing for one day (24 hours) at 100° C.

The weight of the evaluation cup as a whole was measured before and after the test, and post-test weight reduction was calculated.

Post-test weight reduction, etc., were inserted into the following equation to calculate the gas permeation coefficient, and refrigerant permeation resistance was evaluated on the basis of the calculated results.

Gas permeation coefficient (mg·mm/day·cm²)=(M×t)/(T×A)

In the equation, M is the weight reduction (mg), t is the thickness (mm) of the sheet, T is test time (day), and A is permeation area (cm²).

Evaluation results indicating a gas permeation coefficient was 2.0 mg·mm/day·cm² or less were evaluated as indicating very superior refrigerant permeation resistance, designated “A”.

A gas permeation coefficient of greater than 2.0 mg·mm/day·cm² but not greater than 2.4 mg·mm/day·cm² were evaluated as indicating superior refrigerant permeation resistance, designated “B”.

A gas permeation coefficient of greater than 2.4 mg·mm/day·cm² but not greater than 2.6 mg·mm/day·cm² were evaluated as indicating good refrigerant permeation resistance, designated “C”.

A gas permeation coefficient of greater than 2.6 mg·mm/day·cm² were evaluated as indicating poor refrigerant permeation resistance, designated “D”.

### Compression Set Resistance

First, the rubber compositions produced as described above were vulcanized at 153° C. for 45 minutes using a press vulcanizing machine to prepare large test pieces as defined in JIS (Japanese Industrial Standard) K 6262.

Next, in accordance with JIS K 6262, the test pieces prepared as described above were compressed 25% and kept at 70° C. for 22 hours, followed by removing the pressure and letting the pieces stand at ambient temperature for 30 minutes, after which the compression set rate was measured.

A compression set rate of 35% or less can be considered to indicate superior compression set resistance.

### Modulus: M100

The compositions produced as described above were vulcanized at 160° C. for 30 minutes using a press vulcanizing machine to mold 2 mm-thick sheets, and dumbbell-shaped test pieces were prepared.

Next, the 100% modulus (tensile stress of the rubber at 100% elongation in a tensile test) of the test pieces prepared as described above was measured at a tensile test speed of 500 mm/min and 23° C. in accordance with JIS K 6251.

TABLE 1

| | Examples | | | | | | | | | Comparative Examples | | |
|---|---|---|---|---|---|---|---|---|---|---|---|---|
| | 1 | 2 | 3 | 4 | 5 | 6 | 7 | 8 | 9 | 1 | 2 | 3 |
| IIR | 100 | 100 | 100 | 100 | 100 | 90 | 90 | 100 | 100 | 100 | 100 | 100 |
| CSM | | | | | | 10 | | | | | | |
| CM | | | | | | | 10 | | | | | |
| Talc | 90 | 90 | 90 | 90 | 130 | 90 | 90 | 90 | 90 | 90 | 90 | 90 |
| Liquid butyl | 2 | 5 | 10 | 30 | 5 | 5 | 5 | | | | | |
| rubber 1 | | | | | | | | | | | | |
| Liquid butyl | | | | | | | | 2 | 5 | | | |
| rubber 2 | | | | | | | | | | | | |
| Paraffin oil | | | | | | | | | | | | 5 |
| (comparison) | | | | | | | | | | | | |
| Liquid | | | | | | | | | | 5 | | |
| polybutene | | | | | | | | | | | | |
| (comparison) | | | | | | | | | | | | |
| Aromatic oil | | | | | | | | | | | 5 | |
| (comparison) | | | | | | | | | | | | |
| Zinc oxide | 5 | 5 | 5 | 5 | 5 | 5 | 5 | 5 | 5 | 5 | 5 | 5 |
| Resin | 5 | 5 | 5 | 5 | 5 | 5 | 5 | 5 | 5 | 5 | 5 | 5 |
| vulcanizing agent | | | | | | | | | | | | |
| Refrigerant | B | C | C | C | A | C | C | B | C | D | D | D |
| permeation | | | | | | | | | | | | |
| resistance | | | | | | | | | | | | |
| Compression set (%) | 30 | 29 | 29 | 38 | 39 | 30 | 30 | 31 | 31 | 28 | 31 | 29 |
| M100 (MPa) | 6.6 | 6.4 | 6.1 | 5.4 | 6.6 | 6.3 | 6.4 | 6.9 | 6.6 | 6.0 | 6.1 | 6.0 |

The details of the components listed in Table 1 are as follows.

IIR: butyl rubber, trade name: BUTYL 301; produced by LANXESS; weight average molecular weight: 600000

CSM: chlorosulfonated polyethylene, trade name: TS-530; manufactured by Tosoh Corporation

CM: chlorinated polyethylene, trade name: Elaslene 352NA; manufactured by Showa Denko K.K.

Talc: Mistron Vapor (trade name); manufactured by Imerys Specialties Japan Co., Ltd.

Liquid butyl rubber 1: trade name: KALENE 800; manufactured by Royal Elastomers; weight average molecular weight: 36000; viscosity: 150000 cP

Liquid butyl rubber 2: trade name: KALENE 1300; manufactured by Royal Elastomers; weight average molecular weight: 42000; viscosity: 300000 cP

Paraffin oil (comparison): Machine oil 22; manufactured by Showa Shell Sekiyu K.K.

Liquid polybutene (comparison): trade name: HV-300; manufactured by JX Nippon Oil & Energy Corp.

Aroma oil (comparison): trade name: A-OMIX, manufactured by Sankyo Yuka Kogyo K.K.

Zinc oxide: Zinc Oxide #3, manufactured by Seido Chemical Industry Co., Ltd.

Resin vulcanizing agent: brominated alkylphenol-formaldehyde resin; Tackirol 250-I; manufactured by Taoka Chemical Co., Ltd.

As is clear from the results shown in Table 1, Comparative Examples 1 to 3, which contained liquid polybutene, paraffin oil, or aroma oil instead of liquid butyl rubber, had low refrigerant permeation resistance.

In contrast, the rubber compositions according to the present technology were confirmed as yielding the desired effects.

A comparison of Examples 1 to 4 in terms of liquid butyl rubber content showed that refrigerant permeation resistance was better as liquid butyl rubber content decreased.

A comparison of Examples 1 to 4 in terms of liquid butyl rubber content also showed that a liquid butyl rubber content of less than 30 parts by mass per 100 parts by mass of the prescribed rubber component yielded better compression set resistance and a higher modulus than when the said content was 30 parts by mass or greater.

A comparison of Examples 2 and 5 in terms of talc content showed that a talc content of less than 130 parts by mass per 100 parts by mass of the prescribed rubber component yielded better compression set resistance than when the said content was 130 parts by mass or greater.

A comparison of Example 2 and Examples 6 and 7 showed that Example 2, which uses only butyl rubber as the rubber component, had less compression set than Examples 6 and 7.

A comparison of Example 1 and Example 8 showed that Example 1, which contained liquid butyl rubber having a weight average molecular weight of 40000 or less, had better compression set resistance than Example 8, which contained liquid butyl rubber having a weight average molecular weight in excess of 40000. A comparison of Examples 2 and 9 yielded similar results.

1. A rubber composition containing:
a rubber component including at least one selected from the group consisting of chlorosulfonated polyethylene rubber, butyl rubber, and chlorinated polyethylene rubber; and
liquid butyl rubber, the composition being used to manufacture a refrigerant-transporting hose.

2. The rubber composition according to claim 1, wherein the liquid butyl rubber has a weight average molecular weight of 1000 to 50000.

3. The rubber composition according to claim 1, wherein the liquid butyl rubber has a viscosity at 90° C. of 10000 to 600000 cP.

4. The rubber composition according to claim 1, wherein a liquid butyl rubber content is 1 to 30 parts by mass per 100 parts by mass of the rubber component.

5. The rubber composition according to claim 1, wherein the refrigerant includes at least a fluorine-based compound.

6. A refrigerant-transporting hose fabricated using the rubber composition according to claim 1.

7. The rubber composition according to claim 2, wherein the liquid butyl rubber has a viscosity at 90° C. of 10000 to 600000 cP.

8. The rubber composition according to claim 2, wherein a liquid butyl rubber content is 1 to 30 parts by mass per 100 parts by mass of the rubber component.

9. The rubber composition according to claim 3, wherein a liquid butyl rubber content is 1 to 30 parts by mass per 100 parts by mass of the rubber component.

10. The rubber composition according to claim 2, wherein the refrigerant includes at least a fluorine-based compound.

11. The rubber composition according to claim 3, wherein the refrigerant includes at least a fluorine-based compound.

12. The rubber composition according to claim 4, wherein the refrigerant includes at least a fluorine-based compound.
